(19) United States
(12) Patent Application Publication
(10) Pub. No.: US 2009/0021810 A1
(43) Pub. Date: Jan. 22, 2009

(54) METHOD OF SCENE BALANCE USING PANCHROMATIC PIXELS

(76) Inventors: James E. Adams, JR., Rochester, NY (US); Michele O'Brien, Rochester, NY (US); John F. Hamilton, JR., Rochester, NY (US); Bruce H. Pillman, Rochester, NY (US)

Correspondence Address: Frank Pinncelli;Patent Legal Staff, Eastman Kodak Company, 343 State Street, Rochester, NY, 14650-2201, US

(21) Appl. No.: 11/780,510

(22) Filed: Jul. 20, 2007

(51) Int. Cl. H04N 1/46

(52) U.S. Cl. 358/525

(57) ABSTRACT

A method of providing an enhanced image including color and panchromatic pixels, includes using a captured image of a scene that was captured by a two-dimensional sensor array having both color and panchromatic pixels; providing an image having paxels in response to the captured image so that each paxel has color and panchromatic values; converting the paxel values to at least one luminance value and a plurality of chrominance values; and computing scene balance values from the luminance and chrominance values to be applied to an uncorrected image having color and panchromatic pixels that is either the captured image of the scene or an image derived from the captured image of the scene and using the computed scene balance values to provide an enhanced image including color and panchromatic pixels.

### CROSS REFERENCE TO RELATED APPLICATION

Reference is made to commonly assigned U.S. patent application Ser. No. 11/341,206, filed Jan. 27, 2006 by James E. Adams, Jr. et al, entitled “Interpolation of Panchromatic and Color Pixels”, the disclosure of which is incorporated herein.

### FIELD OF THE INVENTION

The present invention relates to providing for detection of scene illuminant and the use thereof to provide automatic scene balance correction in the digital photographic process.

### BACKGROUND OF THE INVENTION

To perform like the human visual system, imaging systems should automatically adapt to changing color casts in scene illumination. Simply put, white objects in a scene must be rendered as white, regardless of whether the scene illuminant was daylight, tungsten, fluorescent, or some other source. This process of automatic white adaptation is called “white balancing” and the corrective action determined by this adaptation mechanism is the white balance correction.

Automatic white balance algorithms employed in automatic printers, digital scanners, and digital cameras conventionally employ the digitized image information and related mathematical techniques to attempt to deduce from the image data the optimum level of white balance correction to be applied on a scene-by-scene basis to the image. It is known that errors in automatic white balance correction occur when the algorithm is unable to differentiate between an overall color cast caused by the scene illuminant and an overall color bias due to the composition of the scene. It is desirable, therefore, to be able to differentiate a color cast due to scene illumination from a color bias due to scene composition. It is also known that white balance errors occur due to color temperature variations within a class of scene illuminant. Late day direct sunlight imposes a yellowish color cast to a scene while skylight on a cloudy day will lend a bluish color cast to a scene. However, both lights are clearly daylight and will require substantially different white balance corrections. It is desirable, therefore, to also be able to account for scene illuminant color temperature variation when determining the white balance correction.

There are many methods described in the literature for determining the scene illuminant of a digital image. Some require special hardware at the time of image capture to make this determination. In commonly-assigned U.S. Pat. Nos. 4,827,119 and 5,037,198 a method of measuring scene illuminant temporal oscillations with the use of a dedicated sensor is described. Daylight will have no oscillation, while tungsten and fluorescent sources will fluctuate in output power due to the AC nature of their power supplies. The problem with any dedicated sensor approach is that it includes two separate data collection and processing paths, one for illuminant detection and another for actual image capture. This leads to the potential of the dedicated sensor path losing synchronization and calibration with respect to the main image capture path. Additionally, the relatively limited amount of information captured by a dedicated sensor can severely limit the robustness of the scene illuminant determination. In commonly-assigned U.S. Pat. Nos. 5,644,358 and 5,659,357 the image data (video input) is combined with a luminance input to perform illuminant classification. (The nature of the luminance input is never described.) Rather than determining an overall illuminant for the scene, a low-resolution version of the image is produced and each image element (or “paxel”) within the low-resolution image is individually classified into one of a number of possible scene illuminants. Statistics are performed on these paxel classifications to derive a compromise white balance correction. The problem with this approach is that no explicit attempt is made to uncouple the effects of scene illuminant color cast from the effects of scene composition. Instead, a complex series of tests and data weighting schemes are applied after the paxel classifications to try to reduce subsequent algorithm errors. Japanese Publication 2001-211458 teaches a method very similar to that described in commonly-assigned U.S. Pat. Nos. 5,644,358 and 5,659,357, and has the same problems.

There are many methods described in the literature for determining a color temperature responsive white balance correction of a digital image. In commonly-assigned U.S. Pat. Nos. 5,185,658 and 5,298,980 a method of measuring the scene illuminant's relative amounts of red (R), green (G), and blue (B) power with dedicated sensors is described. The white balance correction values are derived from the ratios of R/G and B/G, which are considered to be related to the color temperature of the scene illuminant. As with commonly-assigned U.S. Pat. Nos. 4,827,119 and 5,037,198, discussed above, the problem with any dedicated sensor approach is that it includes two separate data collection and processing paths, one for illuminant detection and another for actual image capture, and these two paths can get “out of step” with each other. In the above referenced Japanese Publication 2001-21458, the illuminant classification step is further refined to represent a variety of subcategories within each illuminant class. In this way cooler and warmer color cast versions of the illuminant classes of daylight, tungsten, and fluorescent are determined. However, as stated before, there is no explicit method given for uncoupling illuminant color cast from scene composition variability and, as a result, a variety of involved statistical operations are required in an attempt to reduce algorithmic errors.

In commonly-assigned U.S. Pat. No. 6,133,983 Wheeler discloses a method for optical printing of setting the degree of color correction; i.e. a parameter used to determine the magnitude of applied color balancing to photographic images, based on camera meta-data. In particular, Wheeler discloses using the scene-specific measurements of the scene light level, camera-to-subject distance, flash fire signal, and flash return signal to classify an image as being captured either under daylight or non-daylight illuminant. It is stated that for images captured with daylight-balanced films there is no need to further distinguish the non-daylight illuminants because the same white balance correction methodology works regardless. As a result, commonly assigned U.S. Pat. No. 6,133,983 does not present a method for such subsequent illuminant discrimination. This approach fails when applied to imaging systems requiring further differentiation of non-daylight sources for accurate white balancing, or if any of the image metadata (i.e., scene light level, camera-to-subject distance, flash fire signal, and flash return signal) are corrupt or missing. In particular, the method disclosed by Wheeler requires the scene light level to be a measured quantity.

In conference paper “Usage of DSC meta tags in a general automatic image enhancement system” from the Proceedings of SPIE Vol. #4669, Sensors and Camera Systems for Scientific, Industrial, and Digital Photography Applications III, Jan. 21, 2002, pgs. 259-267, the authors Moser and Schroder describes a method of scene analysis regarding the likelihood of a photographic scene having been influenced by an artificial illuminant light source. The method disclosed by Moser and Schroder uses the camera meta-data of Fnumber (f) and exposure time (t) to calculate a “pseudo” energy (pE) quantity for a digital image derived from a digital camera using the formula:

$$pE = ln ( \frac{t}{{f}^{2}} )$$

Moser and Schroder then use the pE quantity to analyze digital images with regard to the likelihood of the scene illumination source and corresponding resultant color cast. While the method disclosed by Moser and Schroder is useful for analyzing digital images, as disclosed it is not accurate enough to produce consistent automatic white balance correction results for a practical digital enhancement system. This is principally due to the inherent relative, as opposed to absolute, nature of the “pseudo” energy quantity. Two digital cameras with substantially different energy requirements for producing acceptable images will have substantially different “pseudo” energy values for the same scene illumination conditions. Similarly, these same two digital cameras can produce identical “pseudo” energy values when producing digital images with substantially different scene illumination sources.

The problem of automatically analyzing for scene illuminant and performing automatic white balance is also referred to as scene balance. Scene balance analysis typically also includes some degree of exposure adjustment as well as white balance adjustment.

In the prior art, illuminant estimation and balance analysis was performed on images having three color channels, most often red green and blue. With the development of image sensors having panchromatic and color pixels, a need exists to provide improved scene balance performance starting with an image using panchromatic and color pixels.

### SUMMARY OF THE INVENTION

It is an object of the present invention to produce an automatically scene balanced digital color image from a digital image having panchromatic and color pixels.

This object is achieved by a method of providing an enhanced image including color and panchromatic pixels, comprising:

(a) using a captured image of a scene that was captured by a two-dimensional sensor array having both color and panchromatic pixels;

(b) providing an image having paxels in response to the captured image so that each paxel has color and panchromatic values;

(c) converting the paxel values to at least one luminance value and a plurality of chrominance values; and

(d) computing scene balance values from the luminance and chrominance values to be applied to an uncorrected image having color and panchromatic pixels that is either the captured image of the scene or an image derived from the captured image of the scene and using the computed scene balance values to provide an enhanced image including color and panchromatic pixels.

It is an advantage of the present invention that using panchromatic and color pixels produces improved scene balance correction for digital color images. This improvement includes increased accuracy of the scene balance corrections or decreased sensitivity of the scene balance corrections to image noise.

### BRIEF DESCRIPTION OF THE DRAWINGS

FIG. 1 is a perspective of a computer system including a digital camera for implementing the present invention;

FIG. 2 is a block diagram of a preferred embodiment of the present invention;

FIG. 3 is a block diagram showing block 202 in FIG. 2 in more detail;

FIG. 4 is a block diagram showing block 210 in FIG. 2 in more detail;

FIG. 5 is a block diagram showing block 214 in FIG. 2 in more detail;

FIG. 6 is a block diagram showing block 218 in FIG. 2 in more detail;

FIG. 7 is a block diagram of a first alternate embodiment of the present invention;

FIG. 8 is a block diagram of a second alternate embodiment of the present invention;

FIGS. 9A and 9B are a region of pixels used to produce a paxel;

FIGS. 10A-10D is a set of diagrams defining a scene illuminant region; and

FIGS. 11A-11D is a set of diagrams defining a scene illuminant region.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, are selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, the computer program is stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

Before describing the present invention, it facilitates understanding to note that the present invention is preferably used on any well-known computer system, such as a personal computer. Consequently, the computer system will not be discussed in detail herein. It is also instructive to note that the images are either directly input into the computer system (for example by a digital camera) or digitized before input into the computer system (for example by scanning an original, such as a silver halide film).

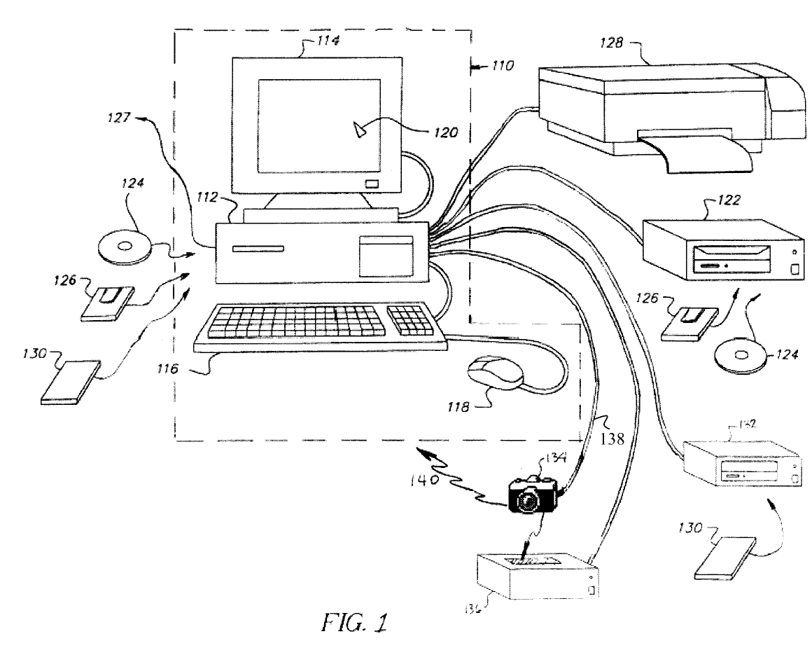

Referring to FIG. 1, there is illustrated a computer system 110 for implementing the present invention. Although the computer system 110 is shown for the purpose of illustrating a preferred embodiment, the present invention is not limited to the computer system 110 shown, but is used on any electronic processing system such as found in home computers, kiosks, retail or wholesale photofinishing, or any other system for the processing of digital images. The computer system 110 includes a microprocessor-based unit 112 for receiving and processing software programs and for performing other processing functions. A display 114 is electrically connected to the microprocessor-based unit 112 for displaying user-related information associated with the software, e.g., by a graphical user interface. A keyboard 116 is also connected to the microprocessor based unit 112 for permitting a user to input information to the software. As an alternative to using the keyboard 116 for input, a mouse 118 is used for moving a selector 120 on the display 114 and for selecting an item on which the selector 120 overlays, as is well known in the art.

A compact disk-read only memory (CD-ROM) 124, which typically includes software programs, is inserted into the microprocessor based unit for providing a way of inputting the software programs and other information to the microprocessor based unit 112. In addition, a floppy disk 126 can also include a software program, and is inserted into the microprocessor-based unit 112 for inputting the software program. The compact disk-read only memory (CD-ROM) 124 or the floppy disk 126 can alternatively be inserted into an externally located disk drive unit 122 which is connected to the microprocessor-based unit 112. Still further, the microprocessor-based unit 112 is programmed, as is well known in the art, for storing the software program internally. The microprocessor-based unit 112 can also have a network connection 127, such as a telephone line, to an external network, such as a local area network or the Internet. A printer 128 can also be connected to the microprocessor-based unit 112 for printing a hardcopy of the output from the computer system 110.

Images are displayed on the display 114 via a personal computer card (PC card) 130, such as, as it was formerly known, a PCMCIA card (based on the specifications of the Personal Computer Memory Card International Association) which contains digitized images electronically embodied in the PC card 130. The PC card 130 is ultimately inserted into the microprocessor based unit 112 for permitting visual display of the image on the display 114. Alternatively, the PC card 130 is inserted into an externally located PC card reader 132 connected to the microprocessor-based unit 112. Images are also input via the compact disk 124, the floppy disk 126, or the network connection 127. Any images stored in the PC card 130, the floppy disk 126 or the compact disk 124, or input through the network connection 127, are obtained from a variety of sources, such as a digital camera (not shown) or a scanner (not shown). Images are also input directly from a digital camera 134 via a camera docking port 136 connected to the microprocessor-based unit 112 or directly from the digital camera 134 via a cable connection 138 to the microprocessor-based unit 112 or via a wireless connection 140 to the microprocessor-based unit 112.

In accordance with the invention, the algorithm is stored in any of the storage devices heretofore mentioned and applied to images in order to automatically scene balance the images.

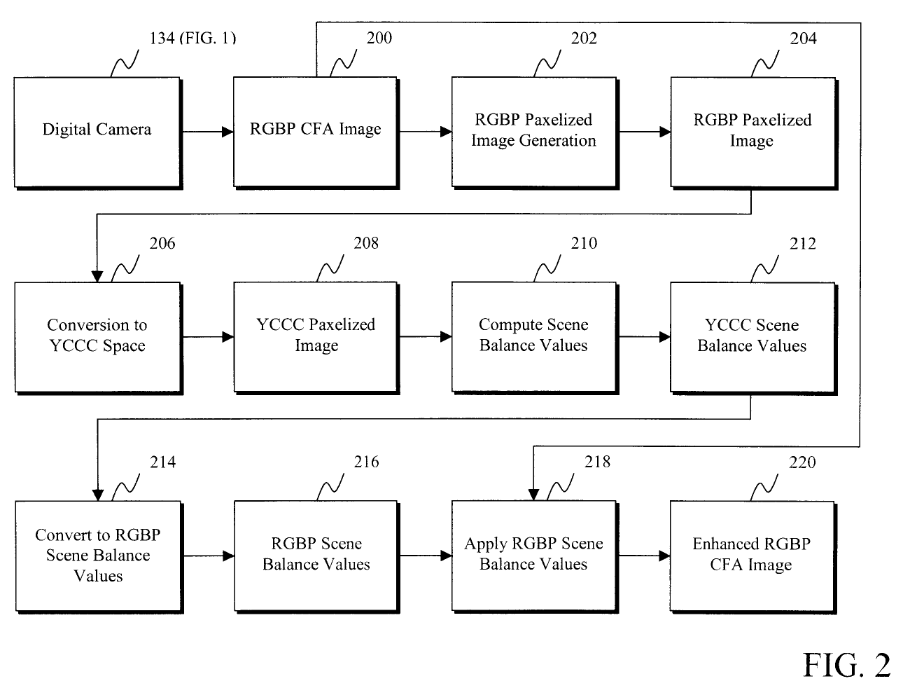

FIG. 2 is a high-level diagram of the preferred embodiment of the present invention. The digital camera 134 (FIG. 1) is responsible for producing an original digital red-green-blue-panchromatic (RGBP) color filter array (CFA) image 200, also referred to as the digital RGBP CFA image or the RGBP CFA image. It is noted at this point that other color channel combinations, such as cyan-magenta-yellow-panchromatic, are also used in place of red-green-blue-panchromatic in the following description. The key item is the inclusion of a panchromatic channel. This image is considered to be a sparsely sampled image because each pixel in the image contains only one pixel value of red, green, blue, or panchromatic data. An RGBP paxelization image generation block 202 produces an RGBP paxelized image 204 from the RGBP CFA image 200. A conversion to YCCC space block 206 produces a YCCC paxelized image 208 from the RGBP paxelized image 204. From the YCCC paxelized image 208, YCCC scene balance values 212 are produced from a compute scene balance values block 210. A convert to RGBP scene balance values block 214 produces RGBP scene balance values 216 from the YCCC scene balance values 212. Finally, an apply RGBP scene balance values block 218 produces an enhanced RGBP CFA image 220 from the RGBP scene balance values 216 and the RGBP CFA image 200.

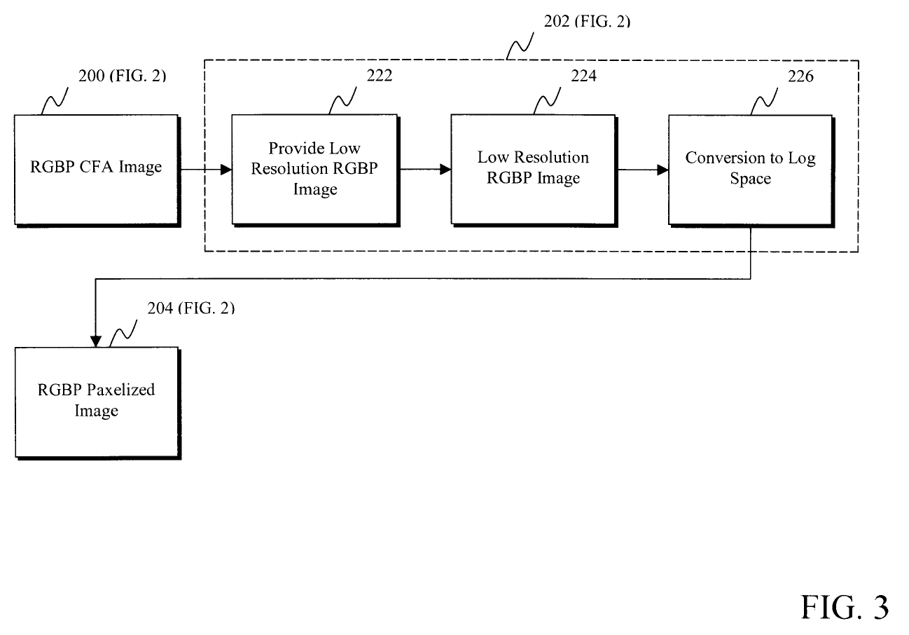

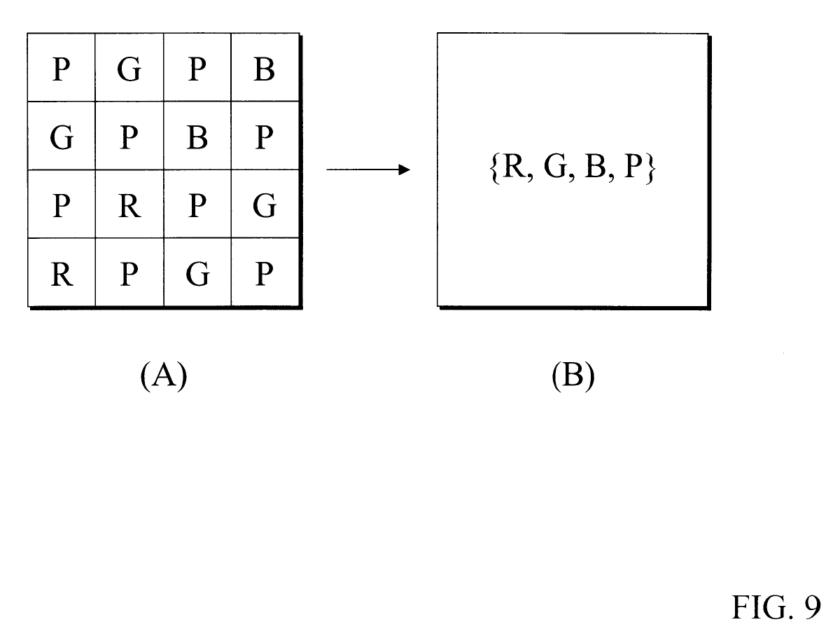

FIG. 3 is a detailed block diagram of the RGBP paxelization image generation block 202 (FIG. 2) for the preferred embodiment. A provide low resolution RGBP image block 222 produces a low resolution RGBP image 224 from the RGBP CFA image 200 (FIG. 2). Providing the low resolution RGBP image is generally performed by averaging several pixel values of a given color together to produce a single low resolution RGBP paxel value. See FIG. 9. FIG. 9A is a region of pixels in the RGBP CFA image 200 (FIG. 2). FIG. 9B is a resulting paxel produced from FIG. 9A. All of the panchromatic (P) values in FIG. 9A are averaged together to produce the panchromatic value of the paxel FIG. 9B. Similarly, all of the green (G) values in FIG. 9A are averaged together to produce the green value of the paxel FIG. 9B. The same operation is performed to produce the red (R) and blue (B) paxel values in FIG. 9B. It should be noted that FIG. 9A can include larger neighborhoods of pixel values from the RGBP CFA image 200 (FIG. 2). Each such neighborhood would be used to produce a single paxel. Each resulting paxel would have panchromatic, red, green, and blue values. The resulting low resolution RGBP image 224 can have any convenient image dimensions with 24 rows by 32 columns being a typical example. The conversion to log space block 226 produces the RGBP paxelized image 204 (FIG. 2) from the low resolution RGBP image 224. It is to be understood that the terms log and logarithm are equivalent and carry the standard mathematical meaning. As an example of block 226, the paxel values of the low resolution RGBP image 224 will be designed by (R, G, B, P) and the paxel values of the RGBP paxelized image 204 (FIG. 2) will be designated by (r, g, b, p). The computation of block 226 then becomes:

$$\{ \begin{matrix}r = 1000 log ( R + 1 ) \\ g = 1000 log ( G + 1 ) \\ b = 1000 log ( B + 1 ) \\ p = 1000 log ( P + 1 )\end{matrix}$$

Returning to FIG. 2, the conversion to YCCC space block 206 produces one luminance and three chrominance values for each paxel in the RGBP paxelized image 204. In the preferred embodiment the following computations are performed by block 206:

$$\{ \begin{matrix}Y = \frac{r + g + b + p}{4} \\ {C}_{1} = r - \frac{g + 2 b + p}{4} \\ {C}_{2} = \frac{( r + 3 b ) - ( 3 g + p )}{4} \\ {C}_{3} = p - \frac{3 g + b}{4}\end{matrix}$$

These computations are widely interpreted as luminance (Y), the color temperature axis (C₁), the green-magenta axis (C₂), and the white-green axis (C₃). It will apparent to one skilled in the art that other computations are used to produce different YCCC values that would still be applicable to the preferred embodiment.

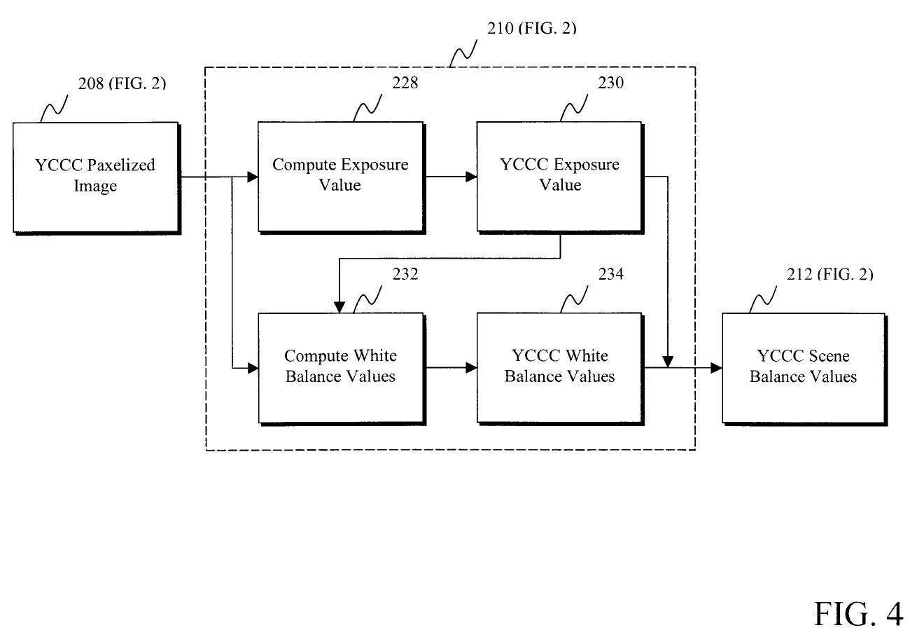

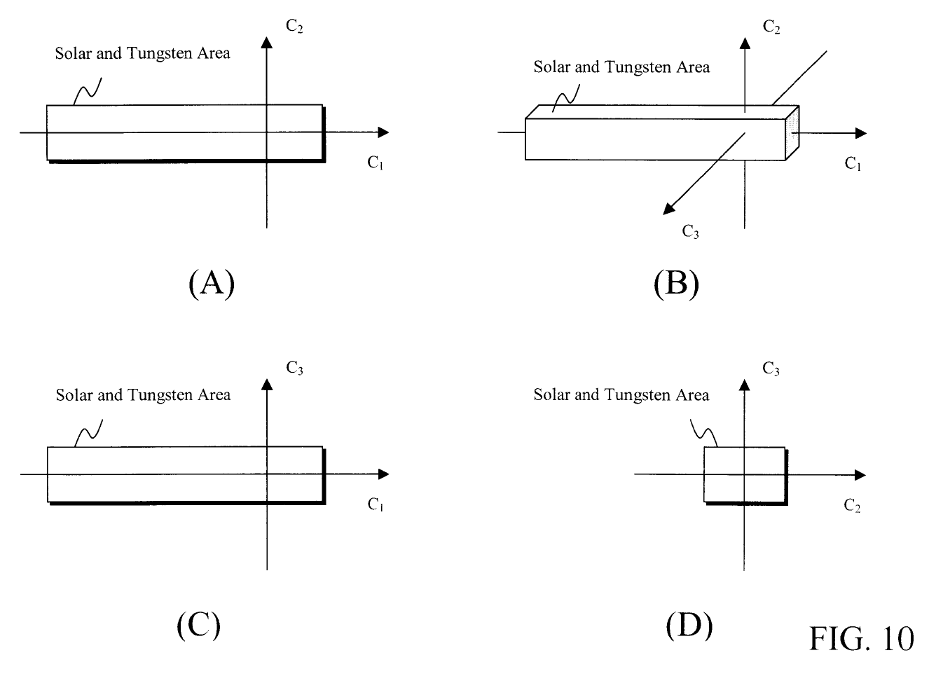

FIG. 4 is a detailed block diagram of the compute scene balance values block 210 (FIG. 2) for the preferred embodiment. A compute exposure value block 228 produces a YCCC exposure value 230 from the YCCC paxelized image 208 (FIG. 2). A compute white balance values block 232 produces YCCC white balance values 234 from the YCCC paxelized image 208 (FIG. 2) and the YCCC exposure value 230. The YCCC exposure value 230 and the YCCC white balance values 234 taken together are the YCCC scene balance values 212 (FIG. 2). The YCCC exposure value 230 produced by the compute exposure value block 228 is the paxel luminance value associated with 18% scene reflectance in the original scene captured by the digital camera 134 (FIG. 1). Any luminance-based method known to those skilled in the art is used in block 228. One such method is described in commonly assigned U.S. Pat. No. 6,573,932 (Adams, et al.) The YCCC white balance values 234 produced by the compute white balance values block 232 are the paxel chrominance values associated with gray (neutral) at 18% scene reflectance. Any chrominance-based method known to those skilled in the art is used in block 232 with the following extension to incorporate the use of the third chrominance channel. As an example, one such method is described in U.S. Pat. No. 5,644,358 (Miyano, et al.) FIG. 10A is a reproduction of FIG. 4 from '358 using the notation of the present invention. In '358, paxels with chrominance values that fall within the region shown in FIG. 10A are classified as being indicative of solar (daylight) or tungsten scene illumination. For the present invention, this classification is extended to include the third chrominance axis in one of two ways. In FIG. 10B, a cuboid is shown in three dimensions. Now, a paxel should have all three chrominance values falling within the cuboid to be classified as a solar or tungsten paxel. An alternate method to achieve the same result it to separately consider FIG. 10A, FIG. 10C, and FIG. 10D when testing the paxel chrominance values. The paxel chrominance values should fall within each region in FIG. 10A, FIG. 10C, and FIG. 10D in order to be classified as a solar or tungsten paxel.

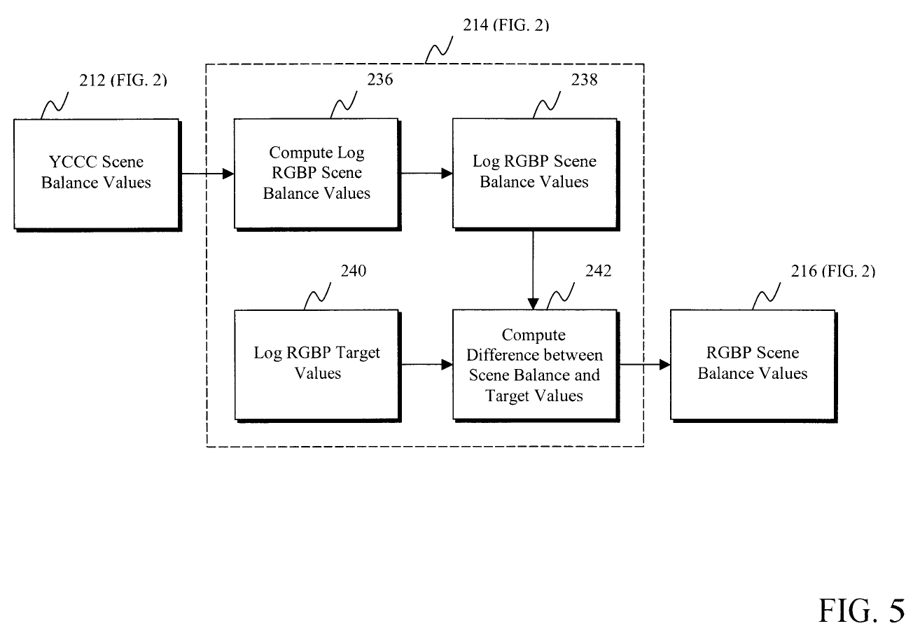

FIG. 5 is a detailed block diagram of the convert to RGBP scene balance values block 214 (FIG. 2) for the preferred embodiment. A compute log RGBP scene balance values block 236 produces log RGBP scene balance values 238 from the YCCC scene balance values 212 (FIG. 2). A compute difference between scene balance and target values block 242 produces RGBP scene balance values 216 (FIG. 2) from the log RGBP scene balance values 238 and log RGBP target values 240. The compute log RGBP scene balance values block 236 performs the inverse computations to the conversion to YCCC space block 206. For the preferred embodiment block 236 performs the following computations:

$$\{ \begin{matrix}r = Y + \frac{38 {C}_{1} + 7 {C}_{2} - 2 {C}_{3}}{53} \\ g = Y + \frac{- 6 {C}_{1} + 29 {C}_{2} - 22 {C}_{3}}{53} \\ b = Y + \frac{- 22 {C}_{1} + 35 {C}_{2} - 10 {C}_{3}}{53} \\ p = Y + \frac{- 10 {C}_{1} - 13 {C}_{2} + 34 {C}_{3}}{53}\end{matrix}$$

The (r, g, b, p) values so computed are the log RGBP scene balance values 238. The log RGBP target values, (r_{T}, g_{T}, b_{T}, p_{T}), are specified to produce correct exposure and white balance adjusted pixel values for an 18% scene reflectance gray region in the enhanced RGBP CFA image 220 (FIG. 2). The (r_{T}, g_{T}, b_{T}) values are used to adjust the color of the corrected 18% scene reflectance gray region and the p_{T} value is used to adjust the exposure of the corrected 18% scene reflectance gray region. The compute difference between scene balance and target values block 242 performs the following computations:

$$\{ \begin{matrix}{r}_{A} = {r}_{T} - r \\ {g}_{A} = {g}_{T} - g \\ {b}_{A} = {b}_{T} - b \\ {p}_{A} = {p}_{T} - p\end{matrix}$$

The (r_{A}, g_{A}, b_{A}, p_{A}) values are the RGBP scene balance values 216 (FIG. 2).

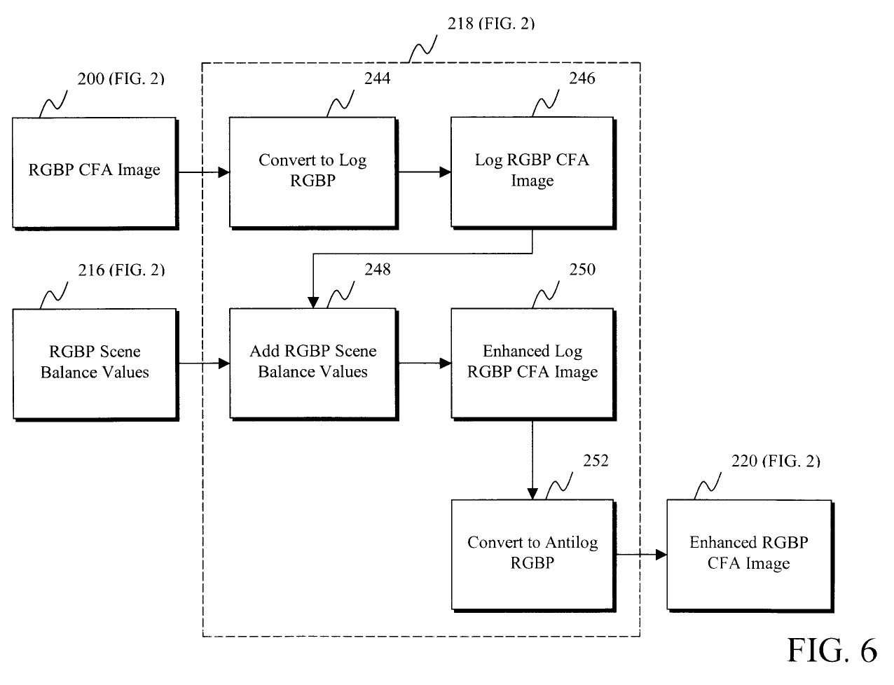

FIG. 6 is a detailed block diagram of the apply RGBP scene balance values block 218 (FIG. 2) for the preferred embodiment. A convert to log RGBP block 244 produces a log RGBP CFA image 246 from the RGBP CFA image 200 (FIG. 2). An add RGBP scene balance values block 248 produces an enhanced log RGBP CFA image 250 from the log RGBP CFA image 246 and the RGBP scene balance values 216 (FIG. 2). Finally, a convert to antilog RGBP block 252 produces the enhanced RGBP CFA image 220 (FIG. 2) from the enhanced log RGBP CFA image 250. The convert to log RGBP block 244 performs the same computations as the conversion to log space block 226 (FIG. 3). The add RGBP scene balance values block 248 performs the following computations:

$$\{ \begin{matrix}{r}_{C} = {r}_{A} + r \\ {g}_{C} = {g}_{A} + g \\ {b}_{C} = {b}_{A} + b \\ {p}_{C} = {p}_{A} + p\end{matrix}$$

where (r, g, b, p) are the log RGBP CFA image 246 values, (r_{A}, g_{A}, b_{A}, p_{A}) are the RGBP scene balance values 216 (FIG. 2), and (r_{C}, g_{C}, b_{C}, p_{C}) are the enhanced log RGBP CFA image 250 values. The convert to antilog RGBP block 252 performs the inverse computations to the convert to log RGBP block 244:

$$\{ \begin{matrix}R = antilog ( r ) - 1 \\ G = antilog ( g ) - 1 \\ B = antilog ( b ) - 1 \\ P = antilog ( p ) - 1\end{matrix}$$

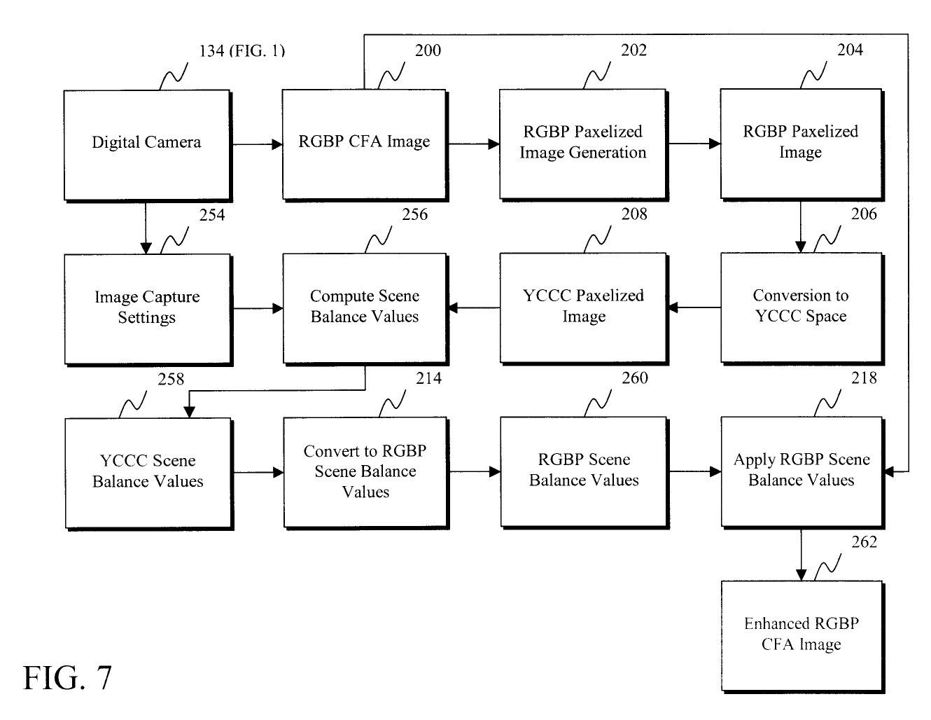

FIG. 7 is a high-level diagram of a first alternate embodiment of the present invention. The digital camera 134 (FIG. 1) is responsible for providing an original digital red-green-blue-panchromatic (RGBP) color filter array (CFA) image 200, also referred to as the digital RGBP CFA image or the RGBP CFA image. It is noted at this point that other color channel combinations, such as cyan-magenta-yellow-panchromatic, are used in place of red-green-blue-panchromatic in the following description. The key item is the inclusion of a panchromatic channel. This image is considered to be a sparsely sampled image because each pixel in the image contains only one pixel value of red, green, blue, or panchromatic data. An RGBP paxelization image generation block 202 produces an RGBP paxelized image 204 from the RGBP CFA image 200. A conversion to YCCC space block 206 produces a YCCC paxelized image 208 from the RGBP paxelized image 204. From the YCCC paxelized image 208 and the image capture settings 254 used by the digital camera 134 (FIG. 1) to produce the RGBP CFA image 200, YCCC scene balance values 258 are produced from a compute scene balance values block 256. A convert to RGBP scene balance values block 214 produces RGBP scene balance values 260 from the YCCC scene balance values 258. Finally, an apply RGBP scene balance values block 218 produces an enhanced RGBP CFA image 262 from the RGBP scene balance values 260 and the RGBP CFA image 200.

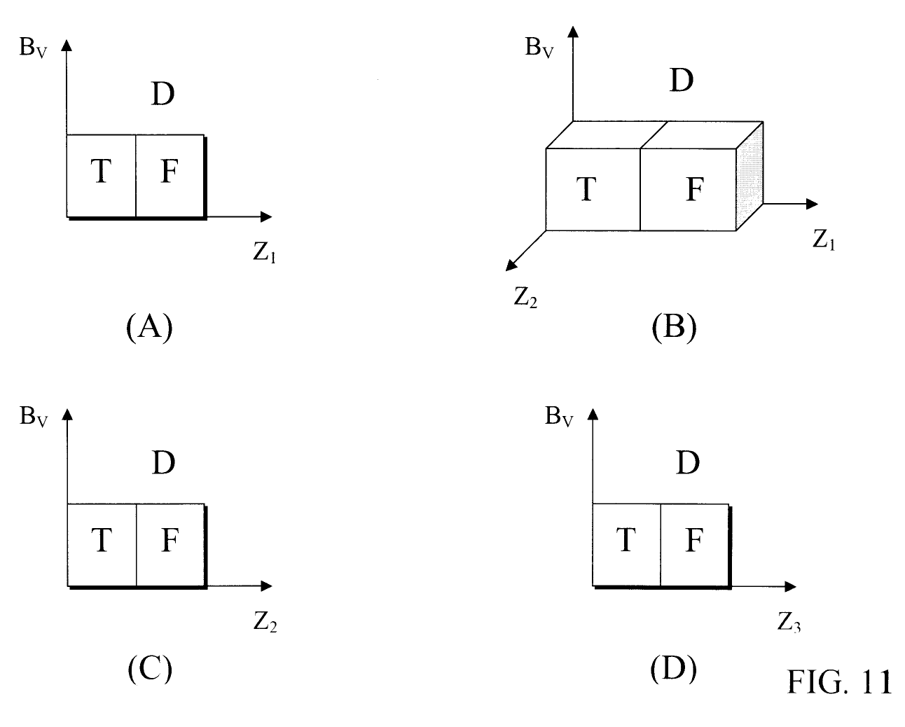

In FIG. 7, blocks 200, 202, 204, 206, 208, 214, and 218 are as described in the preferred embodiment. The image capture settings 254 include the parameter settings used to adjust and control the photometric response of the digital camera 134 (FIG. 1) and the corresponding quality of the produced RGBP CFA image 200. An exemplary set of image capture settings 254 would be the shutter time (t), the aperture setting (f#), and the exposure index (ISO). Any chrominance-based method known to those skilled in the art is used in compute scene balance values block 256 with the following extension to incorporate the use of the third chrominance channel. As an example, one such method is described in commonly assigned U.S. Pat. No. 6,573,932 (Adams, Jr. et al.) FIG. 11A is a graphical representation of the illuminant space employed in FIG. 5 from '932. In FIG. 11A, a brightness value B_{V} is computed from the image capture settings 254 in the following manner:

B_{V}=T_{V}+A_{V}−S_{V}

where

$${T}_{V} = {log}_{2} ( \frac{1}{t} )$$

$${S}_{V} = {log}_{2} ( \frac{ISO}{π} )$$

$${A}_{V} = {log}_{2} ( f {\#}^{2} )$$

A first illuminant score Z₁ is computed by the expression

Z₁=a₁b_{V}+a₂ C̅₁+a₃

where C̅₁ is the average of paxel color temperature axis chromaticity values meeting a set of luminance criteria and (a₁, a₂, a₃) are empirically determined parameters for a given digital camera 134 (FIG. 1). For the YCCC paxelized image 208, the computed values B_{V} and Z₁ are used to determine the scene illuminant at time of capture. If the coordinates (B_{V}, Z₁) fall within the region labeled “D”, the scene illuminant is daylight. Similarly, the region labeled “T” corresponds to tungsten illumination and the region labeled “F” corresponds to fluorescent illumination. FIG. 11B is an extension of FIG. 11A, also previously described in '932. In FIG. 11B, a third dimension corresponding to a second illuminant score Z₂ is added. Z₂ is computed as follows:

Z₂=b₁B_{V}+b₂ C̅₂+b₃

where C̅₂ is the average of paxel green-magenta axis chromaticity values meeting a set of luminance criteria and (b₁, b₂, b₃) are empirically determined parameters for a given digital camera 134 (FIG. 1). The location of the point (B_{V}, Z₁, Z₂) with respect to the labeled three-dimensional regions in FIG. 11B determines the scene illuminant. The regions in FIG. 11C are generalized by extending them to four dimensions with the inclusion of a third illuminant score Z₃, which is computed as follows:

Z₃=c₁B_{V}+c₂ C̅₃+c₃

where C̅₃ is the average of paxel white-green axis chromaticity values meeting a set of luminance criteria and (c₁, c₂, c₃) are empirically determined parameters for a given digital camera 134 (FIG. 1). An alternate method to achieve the same generalization is to separately consider FIG. 11A, FIG. 11C, and FIG. 11D when testing the brightness values and illuminant scores. The brightness values and illuminant scores should fall within the tungsten region in all three cases of FIG. 11A, FIG. 11C, and FIG. 11D in order to be classified as a tungsten scene illuminant. Similarly, the brightness values and illuminant scores should fall within the fluorescent region in all three cases of FIG. 11A, FIG. 11C, and FIG. 11D in order to be classified as a fluorescent scene illuminant. Otherwise, the scene illuminant is daylight.

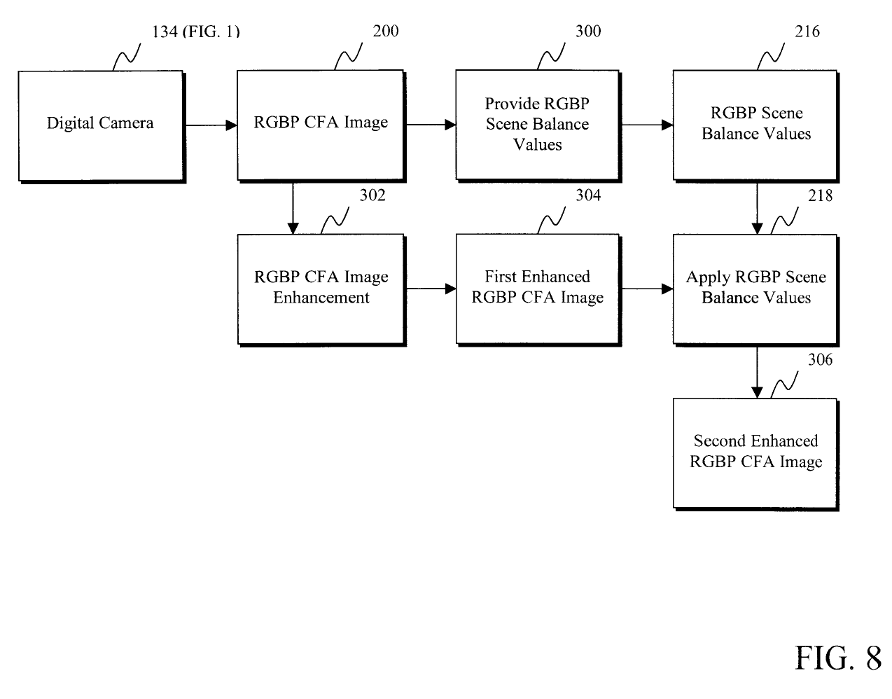

FIG. 8 is a high-level diagram of a second alternate embodiment of the present invention. The digital camera 134 (FIG. 1) is responsible for providing an original digital red-green-blue-panchromatic (RGBP) color filter array (CFA) image 200, also referred to as the digital RGBP CFA image or the RGBP CFA image. It is noted at this point that other color channel combinations, such as cyan-magenta-yellow-panchromatic, are used in place of red-green-blue-panchromatic in the following description. The key item is the inclusion of a panchromatic channel. This image is considered to be a sparsely sampled image because each pixel in the image contains only one pixel value of red, green, blue, or panchromatic data. A provide RGBP scene balance values block 300 produces RGBP scene balance values 216. An RGBP CFA image enhancement block 302 produces a first enhanced RGBP CFA image 304 from the RGBP CFA image 200. An apply RGBP scene balance values block 218 produces a second enhanced RGBP CFA image 306 from the first enhanced RGBP CFA image 304 and the RGBP scene balance values 216.

In FIG. 8, blocks 200, 216, and 218 are as described in the preferred embodiment. The provide RGBP scene balance values block 300 includes blocks 202 through 214 in FIG. 2 as described in the preferred embodiment. It will be apparent to one skilled in the art that, alternately, block 300 can include blocks 202 through 260 in FIG. 7 as described in the first alternate embodiment. Any RGBP CFA image enhancement method known to those skilled in the art is used in the RGBP CFA image enhancement block 302. As an example, one such method is described in commonly assigned U.S. patent application Ser. No. 11/558,571 filed Nov. 10, 2006 by Adams et al.

The scene balance algorithms disclosed in the preferred embodiments of the present invention are employed in a variety of user contexts and environments. Exemplary contexts and environments include, without limitation, are wholesale digital photofinishing (which involves exemplary process steps or stages such as film in, digital processing, prints out), retail digital photofinishing (film in, digital processing, prints out), home printing (home scanned film or digital images, digital processing, prints out), desktop software (software that applies algorithms to digital prints to make them better or even just to change them), digital fulfillment (digital images in—from media or over the web, digital processing, with images out—in digital form on media, digital form over the web, or printed on hard-copy prints), kiosks (digital or scanned input, digital processing, digital or scanned output), mobile devices (e.g., PDA or cell phone that are used as a processing unit, a display unit, or a unit to give processing instructions), and as a service offered via the World Wide Web.

In each case, the scene balance algorithms stand alone or are components of a larger system solution. Furthermore, the interfaces with the algorithm, e.g., the scanning or input, the digital processing, the display to a user (if needed), the input of user requests or processing instructions (if needed), the output, are each on the same or different devices and physical locations, and communication between the devices and locations are via public or private network connections, or media based communication. Where consistent with the foregoing disclosure of the present invention, the algorithms themselves are fully automatic, have user input (be fully or partially manual), have user or operator review to accept/reject the result, or are assisted by metadata (metadata that is user supplied, supplied by a measuring device (e.g. in a camera), or determined by an algorithm). Moreover, the algorithms can interface with a variety of workflow user interface schemes.

The scene balance algorithms disclosed herein in accordance with the invention can have interior components that utilize various data detection and reduction techniques (e.g., face detection, eye detection, skin detection, flash detection).

The invention has been described in detail with particular reference to certain preferred embodiments thereof, but it will be understood that variations and modifications are effected within the spirit and scope of the invention.

### PARTS LIST

110 Computer System
112 Microprocessor-based Unit
114 Display
116 Keyboard
118 Mouse
120 Selector on Display
122 Disk Drive Unit
124 Compact Disk—read Only Memory (CD-ROM)
126 Floppy Disk
127 Network Connection
128 Printer
130 Personal Computer Card (PC card)
132 PC Card Reader
134 Digital Camera
136 Camera Docking Port
138 Cable Connection
140 Wireless Connection
200 RGBP CFA Image
202 RGBP Paxelized Image Generation
204 PGBP Paxelized Image
206 Conversion to YCCC Space
208 YCCC Paxelized Image
210 Compute Scene Balance Values
212 YCCC Scene Balance Values
214 Convert to RGBP Scene Balance Values
216 RGBP Scene Balance Values
218 Apply RGBP Scene Balance Values
220 Enhanced RGBP CFA Image
222 Provide Low Resolution RGBP Image
224 Low Resolution RGBP Image

### PARTS LIST CONT'D

226 Conversion to Log Space
228 Compute Exposure Value
230 YCCC Exposure Value
232 Compute White Balance Values
234 YCCC White Balance Values
236 Compute Log RGBP Scene Balance Values
238 Log RGBP Scene Balance Values
240 Log RGBP Target Values
242 Compute Difference between Scene Balance and Target Values
244 Convert to Log RGBP
246 Log RGBP CFA Image
248 Add RGBP Scene Balance Values
250 Enhanced Log RGBP CFA Image
252 Convert to Antilog RGBP
254 Image Capture Settings
256 Compute Scene Balance Values
258 YCCC Scene Balance Values
260 RGBP Scene Balance Values
262 Enhanced RGBP CFA Image
300 Provide RGBP Scene Balance Values
302 RGBP CFA Image Enhancement
304 First Enhanced RGBP CFA Image
306 Second Enhanced RGBP CFA Image

1. A method of providing an enhanced image including color and panchromatic pixels, comprising:
(a) using a captured image of a scene that was captured by a two-dimensional sensor array having both color and panchromatic pixels;
(b) providing an image having paxels in response to the captured image so that each paxel has color and panchromatic values;
(c) converting the paxel values to at least one luminance value and a plurality of chrominance values; and
(d) computing scene balance values from the luminance and chrominance values to be applied to an uncorrected image having color and panchromatic pixels that is either the captured image of the scene or an image derived from the captured image of the scene and using the computed scene balance values to provide an enhanced image including color and panchromatic pixels.

2. The method according to claim 1 wherein there are three chrominance values and one luminance value for each paxel.

3. The method according to claim 1 wherein step (b) further includes
(i) providing a low resolution color image from the captured image; and
ii) converting such low resolution image to a log space to provide the image having paxels.

4. The method according to claim 1 wherein the scene balance values include white balance values.

5. The method according to claim 1 wherein the scene balance values include an exposure value.

6. The method according to claim 2 wherein step (d) includes
(i) providing YCCC scene balance values from the uncorrected color image;
(ii) computing RGBP scene balance values from the YCCC scene balance values; and
(iii) computing differences between RGBP scene balance values and target values and applying such differences to the uncorrected color image to provide the enhanced color image.

7. The method according to claim 6 wherein the scene balance values and computed differences are logarithmic.

8. The method according to claim 1 wherein step (d) includes
(i) providing RGBP scene balance values from the uncorrected color image;
(ii) converting the uncorrected color image pixel values to logarithmic pixel values;
(iii) providing an enhanced log RGBP CFA image from the RGBP scene balance values and the logarithmic pixel values; and
(iv) computing antilogarithmic pixel values from the enhanced log RGBP CFA image to provide the enhanced RGBP CFA image.

9. The method according to claim 1 further including using image capture setting values in the computation of scene balance values.
